(19) United States
(12) Patent Application Publication
(10) Pub. No.: US 2012/0323968 A1
(43) Pub. Date: Dec. 20, 2012

(54) Learning Discriminative Projections for Text Similarity Measures

(75) Inventors: Wen-tau Yih, Redmond, WA (US); Kristina N. Toutanova, Redmond, WA (US); Christopher A. Meek, Kirkland, WA (US); John C. Platt, Bellevue, WA (US)

(73) Assignee: Microsoft Corporation, Redmond, WA (US)

(21) Appl. No.: 13/160,485

(22) Filed: Jun. 14, 2011

(51) Int. Cl. G06F 17/30

(52) U.S. Cl. 707/780; 707/E17.069; 707/E17.108

(57) ABSTRACT

A model for mapping the raw text representation of a text object to a vector space is disclosed. A function is defined for computing a similarity score given two output vectors. A loss function is defined for computing an error based on the similarity scores and the labels of pairs of vectors. The parameters of the model are tuned to minimize the loss function. The label of two vectors indicates a degree of similarity of the objects. The label may be a binary number or a real-valued number. The function for computing similarity scores may be a cosine, Jaccard, or differentiable function. The loss function may compare pairs of vectors to their labels. Each element of the output vector is a linear or non-linear function of the terms of an input vector. The text objects may be different types of documents and two different models may be trained concurrently.

### BACKGROUND

Measuring the similarity between the text of two words, pages, or documents is a fundamental problem addressed in many document searching and information retrieval applications. Traditional measurements of text similarity consider how similar a search term (e.g., words in a query) is to a target term (e.g., words in a document). Each search term is used to find terms that are similar to itself (e.g. “car”=“car”). As a result, target terms are not identified as similar to a search term unless they are nearly identical (e.g. “car”≠“automobile”). This reliance on requiring an exact match limits the usefulness of search and retrieval applications.

For example, search engines retrieve Web documents by literally matching terms in documents with the terms in the search query. However, lexical matching methods may be inaccurate due to the way a concept is expressed in the Web documents compared to search queries. Differences in the vocabulary and language styles of Web documents compared the search queries will prevent the identification of relevant documents. Such differences arise, for example, in cross-lingual document retrieval in which a query is written in a first language and applied to documents written in a second language.

Latent semantic models have been proposed to address this problem. For example, different terms that occur in a similar context may be grouped into the same semantic cluster. In such a system, a query and a document may still have a high similarity if they contain terms in the same semantic cluster, even if the query and document do not share any specific term. Alternatively, a statistical translation strategy has been used to address this problem. A query term may be considered as a translation of any words in a document that are different from—but semantically related to—the query term. The relevance of a document given a query is assumed proportional to the translation probability from the document to the query.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A discriminative training method projects raw term vectors from a high dimensional space into a common, low-dimensional vector space. An optimal matrix is created to minimize the loss of a pre-selected similarity function, such as cosine, of the projected vectors. A large number of training examples in the high dimensional space are used to create the optimal matrix. The matrix can be learned and evaluated on different tasks, such as cross-lingual document retrieval and ad relevance measure.

The system provides new ranking models for Web search by combining semantic representation and statistical translation. The translation between a query and a document is modeled by mapping the query and document into semantic representations that are language independent rather than mapping at the word level.

A set of text object pairs, which may be, for example, documents, queries, sentences, or the like, are associated with labels. The labels indicate whether the text objects are similar or dissimilar. The label may be a numerical number indicating the degree of similarity. Each text object is represented by a high-dimensional sparse vector. The system learns a projection matrix that maps the raw text object vectors into low-dimensional concept vectors. A similarity function operates on the low-dimensional output vectors. The projection matrix is adapted so that the vector mapping makes the pre-selected similarity function a robust similarity measure for the original text objects.

In one embodiment, a model is used to map a raw text representation of a text object or document to a vector space. The model is optimized by defining a function for computing a similarity score based upon two output vectors. A loss function is based upon the computed similarity scores and labels associated with the pairs of vectors. The parameters of the model are adjusted or tuned to minimize the loss function. In some embodiments, two different sets of parameter models may be trained concurrently. The raw text representation may be a collection of terms from the text object or document. Each term in the raw text representation may be associated with a weighting value, such as Term Frequency, Inverse Document Frequency (TFIDF), or with a term-level feature vector, such as Term Frequency (TF), Document Frequency (DF) or Query Frequency.

The label associated with the two vectors indicates a degree of similarity between the objects represented by the vectors. The label may be a binary number or a real-valued number. The function for computing similarity scores may be a cosine, Jaccard, or any differentiable function. The loss function may be defined by comparing two pairs of vectors to their labels, or by comparing a pair of vectors to its label.

Each element of the output vector may be a linear function of all or a subset of the terms of an input vector. The terms of the input vector may be weighted or unweighted. Alternatively, each element of the output vector may be a non-linear transformation, such as sigmoid, of the linear function.

The text objects or documents being compared may belong to different types. For example, the text objects may be pairs of query documents and advertisement, result, or Web page documents or pairs of English language documents and Spanish language documents.

### DRAWINGS

FIG. 1 illustrates the creation of the low-dimensional concept vectors and the comparison of concept vectors using a similarity function;

FIG. 2 illustrates two groups of text objects used for training the projection matrix;

FIG. 3 illustrates a process for learning an optimized set of parameters for mapping raw text vectors to low-dimensional concept vectors; and

FIG. 4 illustrates a process for applying an optimized set of parameters while comparing a plurality of text objects; and

FIG. 5 illustrates an example of a suitable computing and networking environment on which embodiments may be implemented.

### DETAILED DESCRIPTION

There are many situations in which text-based documents need to be compared and the respective degree of similarity among the documents evaluated. Common examples are Web searches and detection of duplicate documents. In a search, the terms in a query, such as a string of words, are compared to a group of documents, and the documents are ranked based upon the number of times the query terms appear. In duplicate detection, a source document is compared to a target document to determine if they have the same content. Additionally, source and target documents that have very similar content may be identified as near-duplicate documents.

Text similarity can be measured using a vector-based method. When comparing documents, term vectors are constructed to represent each of the documents. The vectors comprise a plurality of terms representing, for example, all the possible words in the documents. The vector for each document could indicate how many times each of the possible words appears in the document (e.g. weighted by term frequency). Alternatively, each term in the vector may be associated with a weight indicating the term's relative importance wherein any function may be used to determine a term's importance.

A pre-selected function, such as cosine or a Jaccard vector similarity function or a distance function, is applied to these and is used to generate a similarity score. This approach is efficient because it requires storage and processing of the term vectors only. The raw document data is not needed once the term vectors are created. However, the main weakness of the term-vector representation of documents is that different—but semantically related—terms are not matched and, therefore, are not considered in the final similarity score. For example, assume the term vector for a first document is: {buy: 0.3, pre-owned: 0.5, car: 0.4}, and the term vector for a second document is: {purchase: 0.4, used: 0.3, automobile: 0.2}. Even though these two vectors represent very similar concepts, their similarity score will be zero for functions such as cosine, overlap, or Jaccard. If the first document in this example is query entered in an Internet search engine, and the second document is a paid advertisement, then the search engine would never find this advertisement, which appears to be a highly relevant result. This problem is even more apparent in cross-lingual document comparison. Because language vocabularies typically have little overlap, the traditional approach is completely inapplicable to measuring similarity between documents written in different languages.

The problems in existing similarity measuring approaches may be addressed in a projection learning framework that discriminatively learns concept vector representations of input text objects. In one embodiment, an input layer corresponds to the original term vector for a document, and an output layer is a projected concept vector that is based upon the original term vector. A projection matrix is used to transform the term vector to the concept vector. The parameters in a model matrix are trained to minimize the loss of similarity scores of the output vectors. Pairs of raw term vectors and their labels, which indicate the similarity of the vectors, are used to train the model.

A projection matrix may be constructed from known pairs of documents that are labeled to indicate a degree of document similarity. The labels may be binary or real-valued similarity scores, for example. The projection matrix maps term vectors into a low-dimensional concept space. This mapping is performed in a manner that ensures similar documents are close when projected into the low-dimensional concept space. In one embodiment, a similarity learning framework is used to learn the projection matrix directly from the known pairs with labeled data. The model design and the training process are described below.

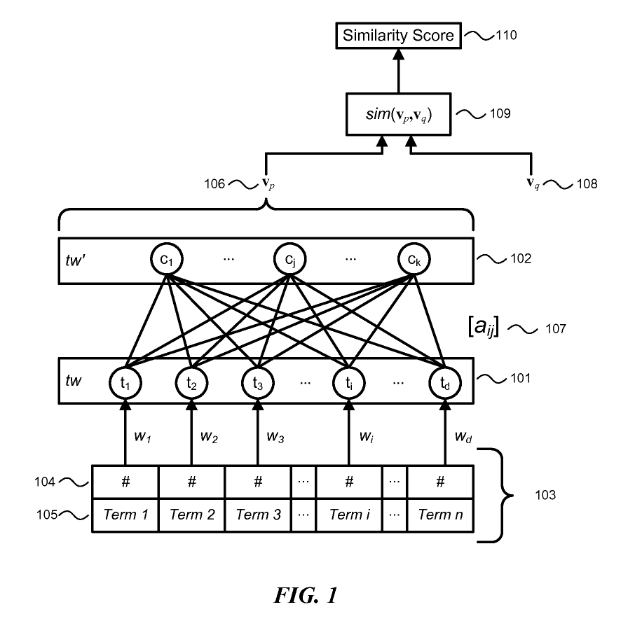

FIG. 1 illustrates the creation of the low-dimensional concept vectors and the comparison of concept vectors using a similarity function. The network structure consists of two layers—an input layer 101 and an output layer 102. The input layer 101 corresponds to an original term vector 103. The input layer 101 has a plurality of nodes tᵢ. Each node tᵢ represents the number of occurrences 104 a term 105 in the original vocabulary. The original vocabulary 105 may represent all of the words that may appear in the text objects of interest or may be a predefined dictionary or set of words. The text objects may be, for example, documents, queries, Web pages or any other text-based item or object. In some embodiments, each element 105 in the term vector may be associated with a term-weighting value wᵢ. In other embodiments, the value may be determined by a function, such as Term Frequency, Inverse Document Frequency (TFIDF).

The output layer 102 is a learned, low-dimensional vector representation in a concept space that captures relationships among the terms tᵢ. Each node cⱼ of the output layer corresponds to an element in a concept vector 106. The output layer 102 nodes cⱼ are each determined by some combination of the weighted terms tᵢ in the input layer 101. The input layer 101 nodes tᵢ or the weighted terms of the original vector may be combined in a linear or non-linear manner to create the nodes cⱼ of the output layer 102. A projection matrix [aᵢⱼ] 107 may be used to convert the nodes tᵢ of the input layer 101 to the nodes cⱼ of the output layer 102.

The original term vector 103 represents a first text object. Concept vector vₚ 106 is created from the first text object. A second concept vector v_{q} 108 is created from a second text object. Concept vectors vₚ 106 and v_{q} 108 are provided as inputs to a similarity function sim(vₚ,v_{q}) 109, such as the cosine function or Jaccard. The framework may also be easily extended to other similarity functions as long as they are differentiable. A similarity score 110 is calculated using similarity function 109.

The similarity score 110 is a measurement of the similarity of the original text objects. Because projection matrix [aᵢⱼ] 107 is used to convert input layer 101 to output layer 102 and to create a concept vector vₓ for each text object, the similarity score 110 is not just a measurement of literal similarity between the text objects, but provides a measurement of the text objects' semantic similarity.

The two layers 101, 102 of nodes form a complete bipartite graph as shown in FIG. 1. The output of a concept node cⱼ may be defined as:

$${tw}^{′} ( {c}_{j} ) = {\sum }_{t\_i ∈ V} {a}_{ij} tw ( {t}_{i} ) \qquad Eq . ( 1 )$$

In other embodiments, a nonlinear activation function, such as sigmoid, may be added to Equation 1 to modify the resulting concept vector.

Using concise matrix notation, let F be a raw d-by-1 term vector, and A=[αᵢⱼ]_{d×k} the projection matrix. The k-by-1 projected concept vector is G=A^{T}F.

For a pair of term vectors, Fₚ and F_{q}, —representing two different text objects—their similarity score is defined by the cosine value of the corresponding concept vectors Gₚ and G_{q} according to the projection matrix A.

$$Similarity Score = {sim}_{A} ( {F}_{p} , {F}_{q} ) = \frac{{G}_{p}^{T} {G}_{q}}{‖ {G}_{p} ‖ ‖ {G}_{q} ‖} \qquad Eq . ( 2 )$$

where Gₚ=A^{T}Fₚ and G_{q}=A^{T}F_{q}.

The label for this pair of term vectors, Fₚ and F_{q}, is y_{pq}. In one embodiment, the mean-squared error may be used as a loss function:

$$\frac{1}{2} {( {sim}_{A} ( {F}_{p} , {F}_{q} ) - {y}_{pq} )}^{2} \qquad Eq . ( 3 )$$

In some embodiments, the similarity scores are used to select the closest text objects given a particular query. For example, given a query document, the desired output is a comparable document that is ranked with a higher similarity score than any other documents with a searched group. The searched group may be in the same language as the query document or in a different, target language. In this scenario, it is more important for the similarity measure to yield a good ordering than to match the target similarity scores. Therefore, a pairwise learning setting is used in which a pair of similarity scores is considered in the learning objective. The pair of similarity scores corresponds to two vector pairs.

For example, consider two pairs of term vectors (Fₚ₁,F_{q1}) and (Fₚ₂,F_{q2}), where the first pair has a higher similarity. Let Δ be the difference of the similarity scores for these pairs of vectors. Namely, Δ=sim_{A}(Fₚ₁,F_{q1})−sim_{A}(Fₚ₂,F_{q2}). The following logistic loss may be used over Δ, which upper-bounds the pairwise accuracy (i.e., 0-1 loss):

L(Δ,A)=log(1+exp(−γΔ)) Eq. (4)

Wherein the scaling factor γ is used with the cosine similarity function to magnify Δ from [−2, 2] to a larger range, which helps penalize more on the prediction errors. Empirically, the value of γ makes no difference as long as it is large enough. In one embodiment, the value of γ is set to 10. Regularization may be done by adding the following term to Equation (4), which prevents the learned model from deviating too far from the starting point:

$$\frac{β}{2} {‖ A - {A}_{0} ‖}^{2} \qquad Eq . ( 5 )$$

The model parameters for projection matrix A may be optimized using gradient-based methods. Initializing the projection model A from a good projection matrix reduces training time and may lead to convergence to a better local minimum. In one embodiment, the gradient may be derived as follows:

$$\begin{matrix}cos ( {G}_{p} , {G}_{q} ) = \frac{{G}_{p}^{T} {G}_{q}}{‖ {G}_{p} ‖ ‖ {G}_{q} ‖} & Eq . ( 6 ) \\ \begin{matrix}{∇}_{A} {G}_{p}^{T} {G}_{q} = ( {∇}_{A} {A}^{T} {F}_{p} ) {G}_{q} + ( {∇}_{A} {A}^{T} {F}_{q} ) {G}_{p} \\ = {F}_{p} {G}_{q}^{T} + {F}_{q} {G}_{p}^{T} Eq . ( 8 )\end{matrix} & Eq . ( 7 ) \\ \begin{matrix}{∇}_{A} \frac{1}{‖ {G}_{p} ‖} = {∇}_{A} {( {G}_{p}^{T} {G}_{p} )}^{- \frac{1}{2}} \\ = - \frac{1}{2} {( {G}_{p}^{T} {G}_{p} )}^{- \frac{3}{2}} {∇}_{A} ( {G}_{p}^{T} {G}_{p} ) Eq . ( 10 ) \\ = - {( {G}_{p}^{T} {G}_{p} )}^{- \frac{3}{2}} {F}_{p} {G}_{p}^{T} Eq . ( 11 )\end{matrix} & Eq . ( 9 ) \\ {∇}_{A} \frac{1}{‖ {G}_{q} ‖} = - {( {G}_{q}^{T} {G}_{q} )}^{- \frac{3}{2}} {F}_{q} {G}_{q}^{T} & Eq . ( 12 )\end{matrix}$$

Let: A=Gₚ^{T}Gₚ, B=1/∥Gₚ∥, C=1/∥G_{q}∥

$${∇}_{A} \frac{{G}_{p}^{T} {G}_{q}}{‖ {G}_{p} ‖ ‖ {G}_{q} ‖} = - {ABC}^{3} {F}_{q} {G}_{q}^{T} - {ACB}^{3} {F}_{p} {G}_{p}^{T} + BC ( {F}_{p} {G}_{q}^{T} + {F}_{q} {G}_{p}^{T} ) \qquad Eq . ( 13 )$$

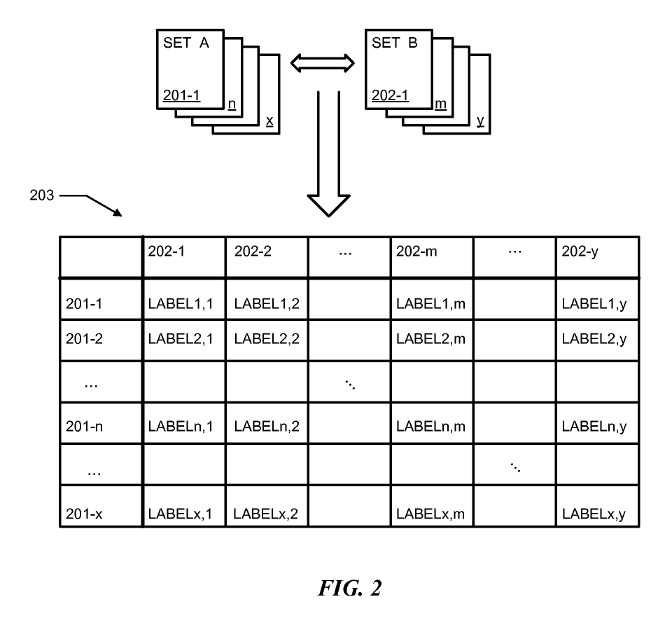

The projection model may be trained using known pairs of text objects. FIG. 2 illustrates two groups of text objects used for training the projection matrix. Each document in a first set of x text objects (SET A) 201 is compared to each document in a second set of y text objects (SET B) 202. Each pair of text objects 201n/202m is associated with a label that indicates a relative degree of similarity between text object 201n and text object 202m. The label may be binary such that a pair of text objects 201n/202m having a degree of similarity at or above a predetermined threshold are assigned a label of “1,” and all other pairs 201n/202m are assigned a label of “0.” Alternatively, any number of additional levels of similarity/dissimilarity may be detected and assigned to the pairs of text objects. A dataset, such as table 203, may be created for the known text objects. The table 203 comprises the labels (LABELm,n) for each pair of known test objects 201n/202m.

In one embodiment, the goal of the system is to take a query document in one language and to find the most similar document from a target group of documents in another language. Known cross-lingual document sets may be used to train this system. For example, SET A 201 may be n documents in a first language, such as English, and SET B 202 may be m documents in a second language, such as Spanish. The labels (LABELm,n) in dataset 203 represent known similarities between the two groups of known documents 201, 202.

In another embodiment, the goal of the system may be a determination of advertising relevance. Paid search advertising is an important source of revenue to search engine providers. It is important to provide both relevant advertisements along with regular search results in response to a user's query. Known sets of queries and results may be used to train the system for this purpose. For example, SET A 201 may be n query strings, and SET B 202 may be m search results, such as advertisements. Each query-ad pair is labeled based upon observed similarity. In one embodiment, the labels may indicate whether the query and ad are similar/dissimilar or relevant/irrelevant.

Using known similarity data, such as the examples above, the projection matrix can be trained to optimize the search or comparison results. In one embodiment, each of the documents Dₙ from the first set of text objects is mapped to compact, low-dimensional vector LDₙ. A mapping function Map is used to map the documents Dₙ to the compact vector LDₙ using a set of parameters Θ. The mapping function has the document D and the parameters Θ as inputs, and the compact vector as the output. For example, LDₙ=Map(Dₙ,Θ). Similarly, each of the documents Dₘ from the second set of text objects is mapped to compact, low-dimensional vector LDₘ using the mapping function Map and the set of parameters Θ. From the known dataset, each pair of documents Dₙ, Dₘ is associated with a label—LABELn,m.

A loss function may be used to evaluate the mapping function and the parameters Θ by making a pairwise comparison of the documents. The loss function has the pair of compact vectors and the label data as inputs. The loss function may be any appropriate function, such as an averaging function, sum of squared error, or mean squared error that provides an error value for a particular set of parameters Θ as applied to the test data. For example, the loss function may be:

$$\begin{matrix}Loss ( {LD}_{n} , {LD}_{m} , LABELn , m ) & Eq . ( 14 ) \\ = Loss ( Map ( {D}_{n} , Θ ) , Map ( {D}_{m} , Θ ) , LABELn , m ) & Eq . ( 15 ) \\ = {\frac{1}{2} [ cos ( {LD}_{n} , {LD}_{m} ) - {LABEL}_{n , m} ]}^{2} & Eq . ( 16 )\end{matrix}$$

Applying an optimization technique, such as gradient descent, to the loss function, the parameters Θ can be improved to minimize loss compared to the known data. The optimization is performed to find the set of parameters Θ at which the Loss function is minimized, thereby identifying the set of parameters Θ having the minimum error value when applied to the known dataset.

$$Arg {Min}_{Θ} {\sum }_{n , m} Loss ( Map ( Dn , Θ ) , Map ( Dm , Θ ) , LABELn , m ) \qquad Eq . ( 17 )$$

Once the optimum set of parameters Θₒₚₜ are identified using the known data, then that set of parameters may be used to compare unknown text objects. For example, the mapping function is applied to the labeled dataset using different parameter sets Θ. When the parameter set Θₒₚₜ is identified for the minimum error value in the loss function, then that set of parameters Θₒₚₜ are used by the search engine, data comparison application, or other process to compare text objects.

In other embodiments, the same or different mapping functions may be used for the first set of text objects and the second set of text objects. For example, mapping function Map₁ may be applied to the first set of text objects, and mapping function Map₂ is applied to the second set of text objects. The mapping function or functions may be linear, non-linear, or weighted.

In other embodiments, the same or different parameter sets Θ may be used for the first set of text objects and the second set of text objects. For example, a first parameter set Θ₁ may be used with the first set of text objects, and a second parameter set Θ₂ may be used with the second set of text objects. The optimization process may optimize one or both parameter sets Θ₁, Θ₂. The parameter sets Θ₁, Θ₂ may be used with the same mapping function or with different mapping functions.

It will be understood that any of the examples described herein are non-limiting examples. As one example, while terms of text objects and the like are described herein, any objects that may be evaluated for similarity may be considered, e.g., images, email messages, rows or columns of data and so forth. Also, objects that are “documents” as used herein may be unstructured documents, pseudo-documents (e.g., constructed from other documents and/or parts of documents, such as snippets), and/or structured documents (e.g., XML, HTML, database rows and/or columns and so forth). As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing, natural language processing and information retrieval in general.

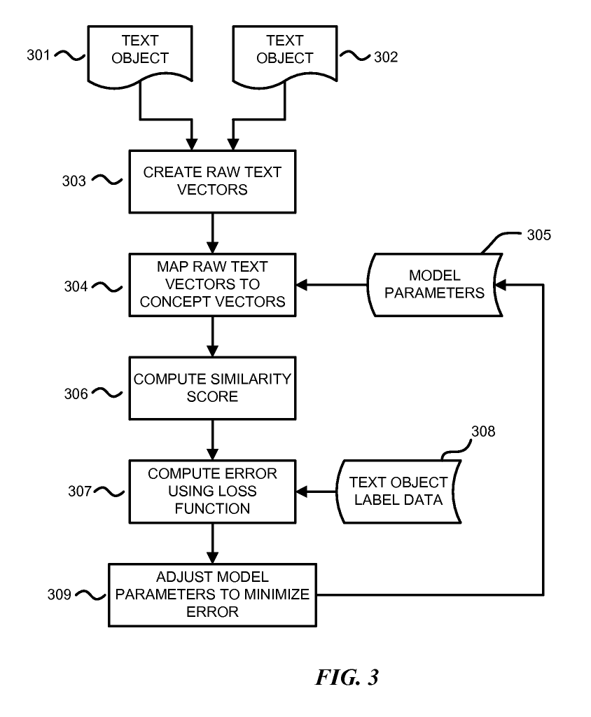

FIG. 3 illustrates a process for learning an optimized set of parameters for mapping raw text vectors to low-dimensional concept vectors. Text objects 301, 302 are analyzed and raw text vectors are created for each text object in step 303. The raw text vectors are mapped to low dimensional concept vectors in step 304. The mapping to the concept vectors may be performed using the same or different mapping functions for text objects 301, 302. The mapping function uses a set of model parameters 305 to convert the raw text vectors to the concept vectors. The same set of model parameters 305 may be used to convert the raw text vector for both text objects 301, 302, or different sets of parameters may be used for text object 301 and text object 302.

In step 306, a similarity score is computed using the concept vectors. The similarity score may be calculated using a cosine function, Jaccard function, or distance measurement between the concept vectors. A loss function is applied to the similarity score to compute an error in step 307. The loss function uses text object label data 308. The label data may comprise, for example, an evaluation of the similarity of text objects 301, 302. The label data may be determined automatically, such as from observations of previous comparisons of the text objects, or manually, such as a human user's evaluation of the relationship between the text objects.

In step 309, the model parameters are adjusted or tuned to minimize the error value calculated by the loss function in step 307. The model parameters 305 may be adjusted after calculating the error for one pair of text objects 301, 302. Alternatively, a plurality of text objects may be analyzed and pairwise loss functions calculated for the plurality of documents. A plurality of corresponding loss functions may be averaged and the average loss function used to adjust the model parameters.

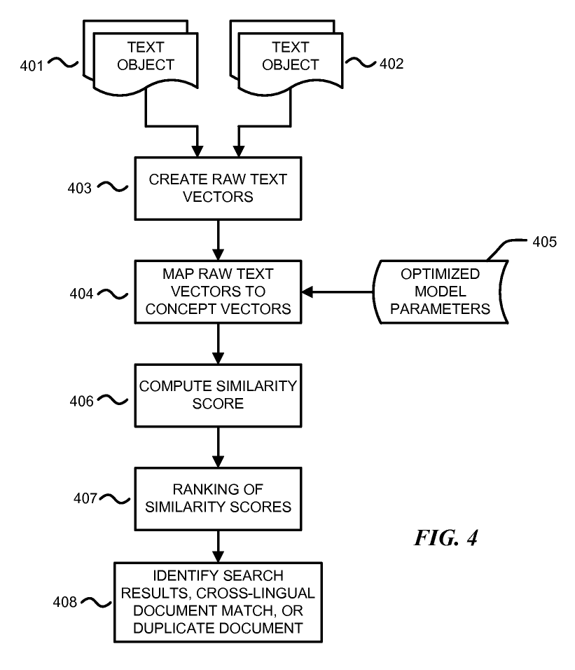

FIG. 4 illustrates a process for applying an optimized set of parameters while comparing a plurality of text objects. Text objects 401, 402 are analyzed and raw text vectors are created for each text object in step 403. The text objects may be, for example, a query (401) and potential search results (402), or a plurality of documents written in a first language (401) and a second language (402), or a document of interest (401) and a plurality of potential duplicate or near-duplicate documents (402). The process illustrated in FIG. 4 may be used to identify a best search result, to match cross-lingual documents, or for duplicate or near-duplicate detection.

The raw text vectors are mapped to low dimensional concept vectors in step 404. The mapping to the concept vectors may be performed using the same or different mapping functions for text objects 401, 402. The mapping function uses a set of model parameters 405 to convert the raw text vectors to the concept vectors. The same set of model parameters 405 may be used to convert the raw text vector for both text objects 401, 402, or different sets of parameters 405 may be used for text object 401 and text object 402. The model parameters 405 are optimized using the procedure in FIG. 3. Once an optimum set of model parameters 405 are identified using a known set of text objects, the parameters are fixed and new or unknown text objects may be processed as illustrated in FIG. 4.

In step 406, a similarity score is computed using the concept vectors. The similarity score may be calculated using a cosine function, Jaccard function, or distance measurement between the concept vectors. In step 407, the similarity scores are ranked for each of the text objects 401 and/or 402. In step 408, the relevant output is generated based upon the ranked similarity scores. The output may comprise, for example, search results among documents 402 based on a query document 401, cross-lingual document matches between document 401 and 402, or documents 402 that are duplicates or near-duplicates of document 401.

The process illustrated in FIG. 4 may be used for many purposes, such as identifying search results, cross-lingual document matches, and duplicate document detection. Additionally, the similarity scores for various documents may be used to identify pairs of similar documents or detecting whether documents are relevant. The identified similar documents may be used to train a machine translation system, for example, if they are in different languages. In the case where the text objects are queries and advertisements, the similarity scores may be used to judge the relevance between the queries and the advertisements. The text objects may also represent words, phrases, or queries and the similarity scores may be used to measure the similarity between the words, phrases, or queries.

In another embodiment, the text objects may be a combination of queries and Web pages. The similarity scores between one of the queries and a group of Web pages may be used to rank the relevance of the Web pages to the query. This may be used, for example, in a search engine application for Web page ranking. The similarity scores may be used directly as a ranking function or as a signal or additional input value to a sophisticated ranking function.

It will be understood that the steps in the process illustrated in FIGS. 3 and 4 may occur in the order illustrated or in any other order. Furthermore, the steps may occur sequentially, or the one or more steps may be performed simultaneously.

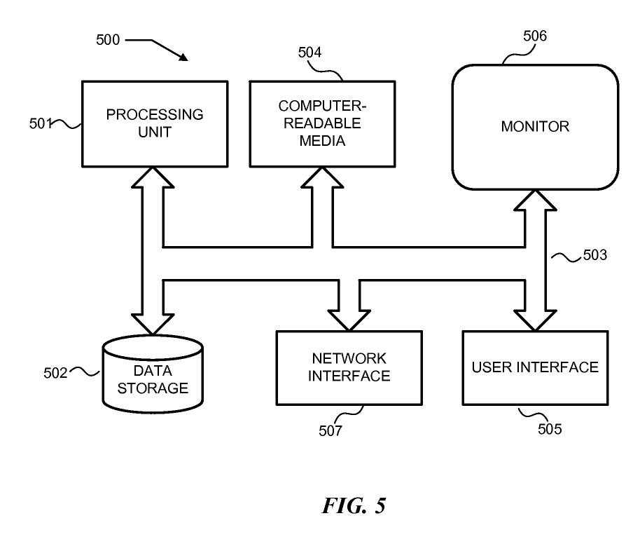

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Computing environment 500 should not be interpreted as having any dependency or requirement relating to any one or combination of components illustrated in the exemplary operating environment 500.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 500. Components may include, but are not limited to, processing unit 501, data storage 502, such as a system memory, and system bus 503 that couples various system components including the data storage 502 to the processing unit 501. The system bus 503 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 500 typically includes a variety of computer-readable media 504. Computer-readable media 504 may be any available media that can be accessed by the computer 501 and includes both volatile and nonvolatile media, and removable and non-removable media. By way of example, and not limitation, computer-readable media 504 may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 500. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The data storage or system memory 502 includes computer storage media in the form of volatile and/or nonvolatile memory such as read only memory (ROM) and random access memory (RAM). A basic input/output system (BIOS), containing the basic routines that help to transfer information between elements within computer 500, such as during start-up, is typically stored in ROM. RAM typically contains data and/or program modules that are immediately accessible to and/or presently being operated on by processing unit 501. By way of example, and not limitation, data storage 502 holds an operating system, application programs, and other program modules and program data.

Data storage 502 may also include other removable/non-removable, volatile/nonvolatile computer storage media. By way of example only, data storage 502 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media, described above and illustrated in FIG. 5, provide storage of computer-readable instructions, data structures, program modules and other data for the computer 500.

A user may enter commands and information into the computer 510 through a user interface 505 or other input devices such as a tablet, electronic digitizer, a microphone, keyboard, and/or pointing device, commonly referred to as mouse, trackball or touch pad. Other input devices may include a joystick, game pad, satellite dish, scanner, or the like. These and other input devices are often connected to the processing unit 501 through a user input interface 505 that is coupled to the system bus 503, but may be connected by other interface and bus structures, such as a parallel port, game port or a universal serial bus (USB). A monitor 506 or other type of display device is also connected to the system bus 503 via an interface, such as a video interface. The monitor 506 may also be integrated with a touch-screen panel or the like. Note that the monitor and/or touch screen panel can be physically coupled to a housing in which the computing device 500 is incorporated, such as in a tablet-type personal computer. In addition, computers such as the computing device 500 may also include other peripheral output devices such as speakers and printer, which may be connected through an output peripheral interface or the like.

The computer 500 may operate in a networked environment using logical connections 507 to one or more remote computers, such as a remote computer. The remote computer may be a personal computer, a server, a router, a network PC, a peer device or other common network node, and typically includes many or all of the elements described above relative to the computer 500. The logical connections depicted in FIG. 5 include one or more local area networks (LAN) and one or more wide area networks (WAN), but may also include other networks. Such networking environments are commonplace in offices, enterprise-wide computer networks, intranets and the Internet.

When used in a LAN networking environment, the computer 500 may be connected to a LAN through a network interface or adapter 507. When used in a WAN networking environment, the computer 500 typically includes a modem or other means for establishing communications over the WAN, such as the Internet. The modem, which may be internal or external, may be connected to the system bus 503 via the network interface 507 or other appropriate mechanism. A wireless networking component such as comprising an interface and antenna may be coupled through a suitable device such as an access point or peer computer to a WAN or LAN. In a networked environment, program modules depicted relative to the computer 500, or portions thereof, may be stored in the remote memory storage device. It may be appreciated that the network connections shown are exemplary and other means of establishing a communications link between the computers may be used.

In some embodiments, the computer 500 may be considered to be a circuit for performing one or more steps or process. Data storage device 502 stores model parameters for use in mapping raw text representations of text objects to a compact vector space. Computer 500 and/or processing unit 501 running software code may be a circuit for creating a compact vector using model parameters, wherein the compact vector represents a text object. Computer 500 and/or processing unit 501 running software code may also be a circuit for generating a similarity score by applying a similarity function to two compact vectors. Computer 500 and/or processing unit 501 running software code may also be a circuit for applying a loss function to the similarity score and to a label. The label identifies a similarity of the text objects associated with the two compact vectors. Computer 500 and/or processing unit 501 running software code may also be a circuit for modifying the model parameters in a manner that minimizes an error value generated by the loss function.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method performed on at least one processor for optimizing model parameters, comprising:
mapping raw text representations of text objects to a compact vector space using the model parameters;
computing similarity scores based upon compact vectors for two text objects;
calculating error values using a loss function operating on the computed similarity scores and labels associated with pairs of text objects; and
adjusting the model parameters to minimize the error values.

2. The method of claim 1, wherein the raw text representation is a term-level feature vector or a collection of terms associated with a weighting value.

3. The method of claim 1, wherein the labels are either binary numbers or real-valued numbers, and the numbers indicate a degree of similarity of the pairs of text objects.

4. The method of claim 1, wherein the text objects are documents, and the method further comprising:
identifying pairs of similar documents in different languages based upon the similarity scores; and
use the pairs of similar documents in different languages to train a machine translation system.

5. The method of claim 1, wherein the text objects are documents, and the method further comprising:
detecting whether the documents are duplicates or near-duplicates based upon the similarity scores.

6. The method of claim 1, wherein the text objects are queries and advertisements, and the method further comprising:
judging relevance between the queries and the advertisements based upon the similarity scores.

7. The method of claim 1, wherein the text objects are queries and Web pages, and the method further comprising:
ranking the relevance of the Web pages to the queries based upon the similarity scores.

8. The method of claim 1, wherein the text objects are words, phrases, or queries, and the method further comprising:
measuring the similarity between the words, phrases, or queries based upon the similarity scores.

9. The method of claim 1, wherein a function for computing similarity scores is selected from a cosine function, a Jaccard function, or any differentiable function.

10. The method of claim 1, wherein the loss function comprises comparing the similarity score for a pair of vectors to a label associated with the pair of vectors.

11. The method of claim 1, wherein each element of the compact vector is a linear or non-linear function of all or a subset of elements of an input vector for the text object.

12. The method of claim 1, wherein each of the text objects in the pairs of text objects are of different types.

13. The method of claim 1, wherein two different sets of model parameters are trained concurrently.

14. A system, comprising:
a data storage device for storing model parameters for use in mapping raw text representations of text objects to a compact vector space;
a circuit for creating a compact vector using model parameters, the compact vector representing a text object;
a circuit for generating a similarity score by applying a similarity function to two compact vectors;
a circuit for applying a loss function to the similarity score and to a label, the label identifying a similarity of the text objects associated with the two compact vectors; and
a circuit for modifying the model parameters in a manner that minimizes an error value generated by the loss function.

15. The system of claim 14, wherein the label is either a binary number or a real-valued number.

16. The system of claim 14, wherein the similarity scores are generated using a function selected from a cosine function, a Jaccard function, or any differentiable function.

17. The system of claim 14, wherein the loss function comprises comparing the similarity score to the label.

18. The system of claim 14, wherein two different sets of model parameters are trained concurrently.

19. One or more computer-readable media having computer-executable instructions, which when executed perform steps, comprising:
mapping raw text representations of text objects to a compact vector space using the model parameters;
computing similarity scores based upon compact vectors for two text objects;
calculating error values using a loss function operating on the computed similarity scores and labels associated with pairs of text objects, wherein the labels indicate a degree of similarity of the pairs of text objects; and
adjusting the model parameters to minimize the error values.

20. The computer-readable media of claim 19, wherein a function for computing similarity scores is selected from a cosine function, a Jaccard function, or any differentiable function; and
wherein the loss function comprises comparing the similarity score for a pair of vectors to a label associated with the pair of vectors.
